(19) United States
(12) Patent Application Publication
(10) Pub. No.: US 2026/0111840 A1
(43) Pub. Date: Apr. 23, 2026

(54) RFID-Enabled Scale Device for Automated Inventory Management and Weight Tracking

(71) Applicant: Triton Equities, LLC, Richardson, TX (US)

(72) Inventor: Quentin Sauvage, Richardson, TX (US)

(21) Appl. No.: 19/366,332

(22) Filed: Oct. 22, 2025

Related U.S. Application Data
(60) Provisional application No. 63/710,166, filed on Oct. 22, 2024.
(60) Provisional application No. 63/719,323, filed on Nov. 12, 2024.

(51) Int. Cl. G06Q 10/087; G06K 7/10; G06K 7/14

(52) U.S. Cl. CPC G06Q 10/0877; G06K 7/10366; G06K 7/1413; G06K 7/1417

(57) ABSTRACT

A system for reconciling inventory includes a scale configured to weigh a container having inventory disposed therein. An identification tag is disposed on the container having scannable indicia disposed thereon containing data about the inventory. A reader is configured to scan and read the scannable indicia and provide the data to a smart device. A processor is configured to analyze the data from the identification tag and a weight value from the scale to determine an updated quantity of inventory in the container, the processor comparing the updated quantity of inventory against a known quantity of inventory to determine an inventory discrepancy, the processor displaying the inventory discrepancy on the smart device.

### CROSS-REFERENCE TO RELATED APPLICATIONS

This application claims the benefit of, and priority to, U.S. Provisional Patent Application Nos. 63/710,166 filed Oct. 22, 2024, and 63/719,323 filed on Nov. 12, 2024, the entire contents of each of which are hereby incorporated herein by reference.

### FIELD OF THE INVENTION

The present disclosure relates to inventory management systems and, more specifically, to a method and system for linking item identification tags with scale-based weight measurements for automatic reconciliation with internal or external inventory databases.

### BACKGROUND OF THE INVENTION

Traditional inventory cycle counts require manual data entry and dedicated equipment to read product identifiers and weights. These systems often suffer from poor integration, high cost, and lack of flexibility across hardware platforms. Modern approaches still rely on physical counting and recording data into inventory management systems or other computer programs. Thus, there exists a need for a platform-independent system that can link containers identified by identification tags such as RFID, barcodes, or QR codes to weights collected from standard RS232 or USB-connected scales, and reconcile that data with inventory systems in real-time.

### SUMMARY

To the extent consistent, any or all of the aspects detailed herein may be used in conjunction with any or all of the other aspects detailed herein.

Provided in accordance with the present disclosure is a system for reconciling inventory which includes a scale configured to weigh a container having inventory disposed therein. An identification tag is disposed on the container, the identification tag including scannable indicia disposed thereon containing data about the inventory. A reader is configured to scan and read the scannable indicia and provide the data to a smart device. A processor disposed in the smart device or scale is configured to analyze the data from the identification tag and a weight value from the scale to determine an updated quantity of inventory in the container, the processor comparing the updated quantity of inventory against a known quantity of inventory stored in the processor or a cloud database to determine an inventory discrepancy, the processor displaying the inventory discrepancy on the smart device.

In aspects in accordance with the present disclosure, the data on the identification tag includes a name of the inventory, a SKU of the inventory, unit weight of the inventory, weight data of the inventory, quantity of the inventory, expiration date of the inventory, room and location of where the inventory reconciliation took place, or where the container is located.

In aspects in accordance with the present disclosure, the scale is configured to communicate the weight value to the smart device via a communication cable, wirelessly, or via a camera.

In aspects in accordance with the present disclosure, the reader is configured to communicate with a cloud database which stores data relating to the container and inventory.

In aspects in accordance with the present disclosure, the processor includes a comparison engine configured to associate the identification tag with the weight value and compare the result to stored data. In other aspects in accordance with the present disclosure, the processor includes an output module configured to update the result in real time.

In aspects in accordance with the present disclosure, the identification tag is at least one of a RFID tag, barcode, or QR code.

In aspects in accordance with the present disclosure, the reader is at least one of a RFID reader, a barcode reader, or a camera.

In aspects in accordance with the present disclosure, the processor is configured to communicate with the cloud database to reconcile inventory discrepancies with an external inventory management system. In other aspects in accordance with the present disclosure, inventory discrepancies are logged with a selectable reason for each discrepancy.

In aspects in accordance with the present disclosure, the comparison engine is configured to calculate a unit weight based on an entered number of units and a measured total weight of inventory within the container.

In aspects in accordance with the present disclosure, upon scanning the identification tag with the reader, the system is configured to retrieve and pre-populate details of the container including at least one of a container name, a SKU, a unit weight, and inventory contents based on a tracking identifier obtained from an external inventory management system.

In aspects in accordance with the present disclosure, the system further comprises an automation engine configured to execute rule-based triggers defined as IF-THEN statements, wherein each rule includes a condition associated with a container, and a corresponding action to be performed when the condition is satisfied, including automated re-ordering of inventory when a weight or unit threshold is reached.

In aspects in accordance with the present disclosure, the system adapted to integrate with at least one of a Point-Of-Sale (POS) system, enterprise resource planning (ERP) system, or a warehouse management software (WMS) system to determine if there is a discrepancy in the inventory.

Provided in accordance with the present disclosure is a method for reconciling inventory, and includes: configuring a scale to weigh a container having inventory disposed therein; scanning an identification tag disposed on the container with a reader, the identification tag including scannable indicia disposed thereon containing data about the inventory; providing the data to a smart device; analyzing the data from the identification tag with a processor disposed in the smart device or scale and a weight value from the scale to determine an updated quantity of inventory in the container; comparing the updated quantity of inventory against a known quantity of inventory stored in the processor or a cloud database to determine an inventory discrepancy; and displaying the inventory discrepancy on the smart device.

In aspects in accordance with the present disclosure, the method further comprises integrating with at least one of a Point-Of-Sale (POS) system, enterprise resource planning (ERP) system, or a warehouse management software (WMS) system to determine if there is a discrepancy in the inventory.

In aspects in accordance with the present disclosure, the method further comprises logging discrepancies between the updated quantity of inventory and the known quantity of inventory with a user defined reason.

### BRIEF DESCRIPTION OF DRAWINGS

The above and other aspects and features of the present disclosure will become more apparent in view of the following detailed description when taken in conjunction with the accompanying drawings wherein like reference numerals identify similar or identical elements.

FIG. 1 is a perspective view of a smart storage device system, including a reader, identification tag, scale, bin/container, communication cable, and a smart device;

FIG. 2 is a perspective view of the system of FIG. 1 connected to a computer;

FIG. 3 is a perspective view of the system of FIG. 1 connected to an integrated hardware device; and

FIG. 4 is an exploded, perspective view of the smart storage device system of FIG. 1 showing internal components therein.

### DETAILED DESCRIPTION

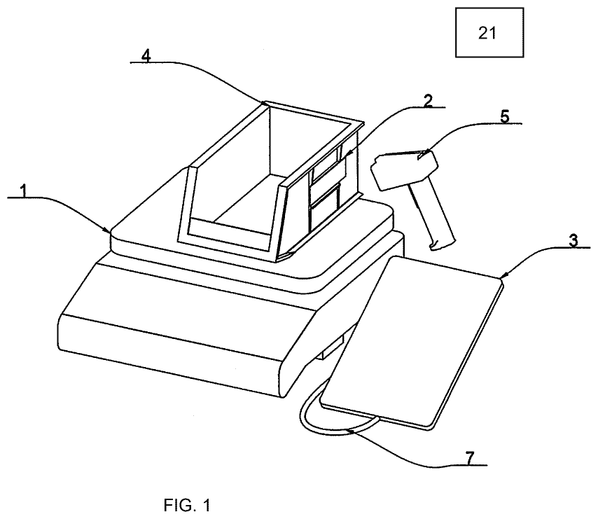

Turning to FIGS. 1-4, a smart storage system 10 provided in accordance with the present disclosure is shown generally including a smart scale 1, a container 4, a handheld reader 5, a smart device 3 and an identification tag 2 (ID tag 2). As explained in more detail below, the smart scale 1 may be configured to include various internal components that cooperate to weigh the contents of the container 4, analyze the contents therein for various purposes and convey the information to the smart device 3 for display thereon. Although particular configurations are detailed below with respect to size, shape, materials, hardware, etc. of the various components of the system 10, the present disclosure is not limited thereto as other suitable configurations are also contemplated. Further, reference herein to a “user” includes anybody that interacts with the system 10, physically or digitally, for the ultimate purpose of accessing the contents thereof and may include customers, employees, and non-commercial parties such as individuals, parents, children, etc. Reference herein to an “administrator” or “user” includes anybody that monitors the system 10 and may include employees, business managers, business owners, and non-commercial parties such as individuals, parents, children, etc.

For the purposes herein, the term handheld reader 5 may include any type of reader that is configured to read bar codes, QR codes, RFID tags, etc. Information provided on the ID tag 2 may be received by the handheld reader 5 and be transmitted wirelessly to the smart device 3 or may be transmitted over communication cable 7 from the smart scale 1.

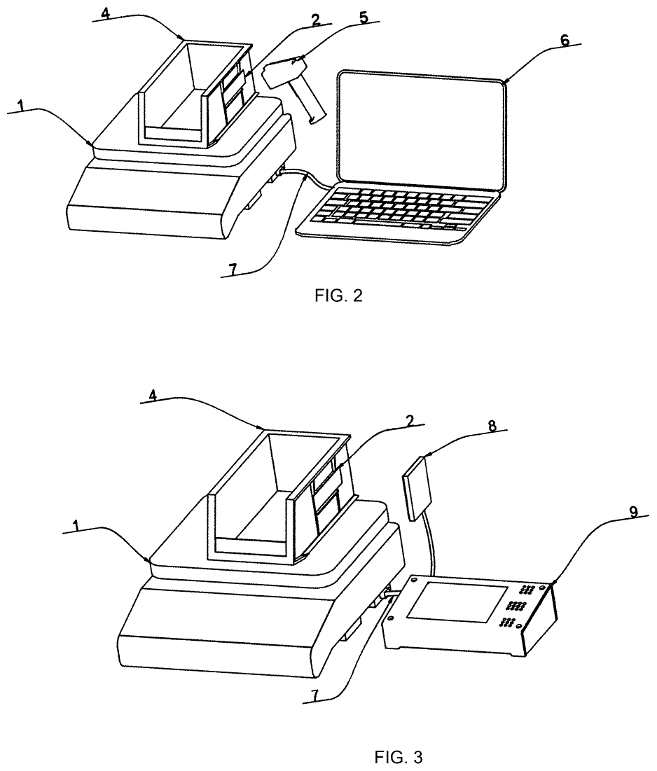

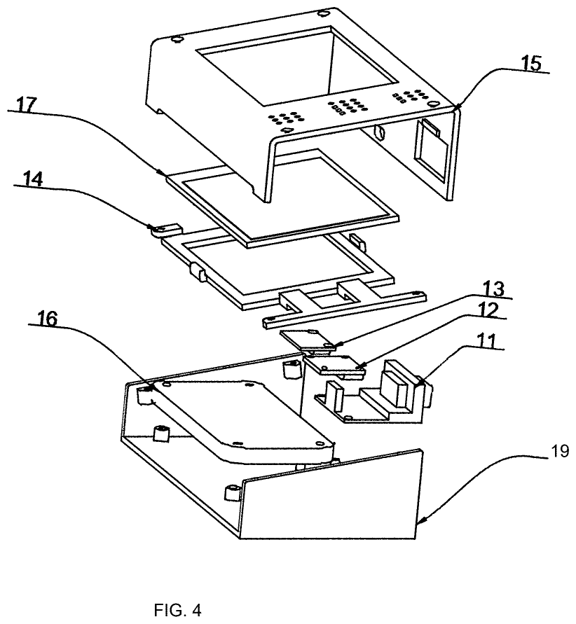

For the purposes herein, the smart device 3 may be any mobile device such as a smart phone, smart pad, or the like (FIG. 1). The smart device 3 may also be a laptop computer 6 (FIG. 2), desktop computer or any integrated hardware 9 (FIG. 3) connected via cable 7 that is capable of displaying information relating to the contents in the container 4. For example, the smart device 3, integrated connected hardware 9, or laptop 6 running a web application may be used to coordinate ID tag 2 input and weight measurements to reconcile data, and transmits results to a cloud database.

ID tag 2 may be fixed to the container 6 (or other storage medium, e.g., pallet, box, jar, crate, etc.) and is configured to store information about content inventory, e.g., content identification (for verification purposes and configuration purposes), whether the contents should be measured in weight values or unit quantity, etc. This information is communicated to the smart scale 1 (or smart device) prior to scale measurement to determine the quantity in the container 4. As best shown in FIG. 4, a PCB 16 may be included with the system 10 either disposed within the smart scale 1 (not shown) or associated with integrated connected hardware 9 (FIG. 4). A processor is disposed on the PCB 16 (hereinafter processor 16) and is configured to analyze the information from the handheld reader 5 (or integrated reader 8 (FIG. 3)) embedded within the ID tag 2, information from the smart scale, and information stored within the processor 16. The processor 16 is then configured to communicate with the smart device 3, laptop 6 or integrated hardware 9 to display information related to the contents disposed within the container 4. As shown in FIG. 4, the processor 16 is disposed within the housing 19 and is in electrical communication with various inputs such as RS232 input 11, USB Input 12, and power input 13. ID tag 2 input may be received via wireless hardware or a connection cable 7, which can include USB, UART, embedded readers, or one or more cameras.

The processor 16 may include information relating to other external parameters that may affect the weight of the contents in the container 4. For example, weight measurements may be affected by geographic location. This is especially significant when there is a need for highly precise weight measurements of inventory. Moreover, the weight of the contents of the container 4 may be affected by humidity especially for highly absorbent goods disposed within the container 4. Other external parameters are also envisioned that may affect weight which may be dependent on the specific contents of the container 6. The processor 16 may be programmed to adjust the weight calculations or unit calculations based on these external parameters. Alternatively, the smart device 3 may be configured to display both the actual weight or unit measurement and the approximated measurement based on one or more of these external parameters.

Weight data from the container 4 may be captured through a scale connection cable 7 via RS232 or USB, an OCR-based camera reading the visual display on the scale, or via wireless communication to a wireless device including but not limited to: smart device 3, laptop 6 (or desktop), or the integrated connected hardware 9 configured to interface directly with the scale 1. As mentioned above, weight data can be displayed either in “weight mode” or “unit mode”. Weight mode takes the entire weight value of the container 4 placed onto the scale 1, subtracts the weight value assigned to the container 4, and captures the weight value of the inventory contents placed in the container 4. Unit mode takes the entire weight value of the container 4 placed onto the scale 1, subtracts the weight value assigned to the container 4 and captures the weight value of the inventory contents placed in the container 4. The system divides the total weight value of the inventory contents by the unit weight value assigned to the inventory contents to display and capture the quantity of inventory contents placed in the container 4.

Once the inventory is determined, the system 1 is configured to communicate with one or more third party platforms to manage inventory. An external integration module may be utilized for this purpose. An external integration module allows synchronization with third-party systems, including ERP, WMS, and compliance platforms such as Metrc and BioTrack. The processor 16 may include a comparison engine or algorithm to compare inventory to note discrepancies. An output module may be configured to output the results from the processor 16 in real time.

The system 1 may also be configured to include an automation engine that allows users to define rule-based triggers based on conditions associated with specific rooms or locations. Before performing a scale 1 update, the user selects a room context, which may represent a physical area, workflow stage, or inventory zone. For example, the system 10 can be configured with one or more automation rules. An automation rule consists of an IF-THEN structure, where IF the condition is validated, THEN the automation is completed. Examples of IF conditions include: (1) current time is within a specified range (e.g., shift windows or scheduled times), (2) measured weight exceeds or falls below a defined threshold, (3) an ID tag 2 or SKU matches a predefined pattern, or (4) simply set to always evaluate as TRUE.

When the condition is met, the THEN action is executed automatically. Actions may include, but are not limited to: (1) sending an email or push notification, (2) updating a record in the internal database or an external database, (3) triggering an API call to another system, (4) flagging a discrepancy for review, or (5) logging the event for audit purposes

The system 10 may also be configured to include anti-theft procedures or mechanisms that determine if inventory deductions from the container 4 are legit transactions or theft. The system 10 may be configured to integrate with Enterprise Resource Planning (ERP), Warehouse Management Software (WMS) or other third-party software. When inventory, either units or weight, is removed from a container 4, the inventory transaction is cross-referenced with the third-party software to determine the cause, e.g., theft.

Turning back briefly to FIG. 1, one embodiment of the system 10 is shown including the smart device 3. Smart device 3 is configured to communicate directly with the scale 1 either wirelessly or via cable 7. When in operation, the smart device 3 displays the measured weight value if the system 10 is operating in weight mode or displays the calculated unit quantity if the system 10 is operating in unit mode. The smart device 3 may also be configured to display the name of the inventory associated with the container 4, the location of the container 4 within the business or building, and the time and user associated with the most recent inventory update.

Smart device 3 may also be configured to communicate with the handheld reader 5, fixed reader 8 of the integrated connected hardware 9, or some other type of scanner. The information embedded on the ID tag 2 may be associated with the inventory contents within a container 4, the measured weight, and all data points are reconciled within the application interface. The computing application, running natively on the smart device 3 transmits the reconciled data to a cloud database and may be configured to synchronize with one or more of the above external inventory systems. Alternatively, the scale 1 may reconcile the data.

In another embodiment shown in FIG. 2, the weight monitoring device may be a laptop or desktop computer 6. Similar to the smart device 3, the laptop 6 communicates with scale 1 via cable 7 or with a wireless interface. The laptop 6 is configured to run a web or desktop application which displays weight values in weight mode or inventory quantities in unit mode. The laptop 6 native application may be configured to display the name of the inventory associated with the container 4, the location of the container 4 within the business or building, and the time and user responsible for the last inventory update. The laptop 6 identifies the container 4 and inventory contents by scanning the ID tag 2 using the handheld reader 5, fixed reader 8, or other form of embedded scanning modules. The information associated with the scanned ID tag 2 regarding the inventory contents within the container 4, the measured weight, and all data points are reconciled within the laptop 6 application interface and optionally initiates reconciliation with ERP or WMS systems or other third-party software.

FIG. 3 shows yet another embodiment of the system 10 configured with integrated connected hardware 9. Integrated connected hardware 9 includes a housing 19 that contains internal electronical components and provides structural support. The housing 19 includes an RS232 input 11, a USB input 12 for connection to scale 1 and other peripheral devices, and a power input 13 for connection to an electrical power supply. Integrated connected hardware 9 also may include a screen holder 14 mounted to a top 15 of housing 19 which is configured to support a graphical display 17. A PCB including processor 16 is disposed within the housing 19 and is disposed in electrical communication with one or more of the inputs 11, 12, and/or 13. The processor 16 includes processing circuitry configured to analyze ID tag 2 data with weight data received from the scale 1.

The graphical user interface (GUI) 17, either non-touch screen or touch screen, is disposed on the screen holder 14 and is configured to display, in real time, one or more of: (i) a weight value of inventory contents measured in weight mode, (ii) an estimated quantity of inventory contents measured in unit mode, (iii) container 4 information associated with ID tag 2, (iv) the name of the inventory associated with container 4, (v) the location of the container 4 within the business or building, and (vi) the time and user responsible for the most recent inventory update, and/or (vii) the connectivity status of the device.

In embodiments, the system 10 may be integrated with one or more cameras or optical reading devices 21 which are configured to cooperate with the weight monitoring device, e.g., smart device 3. Camera 21 is configured to capture data displayed on the GUI 17, scale 1, and/or smart device 3. The data may include ID tag 2 data, weight values on the scale 1, graphically displayed data on the GUI 17 or smart device 3. The camera 21 may utilize optical character recognition to convert the image on the camera 21 to data which may then be communicated to any of the above-mentioned third-party software systems, POS system, ERP system, or WMS system. The same or different camera 21 may be configured to capture barcode, RFID, or QR information from the ID tag 2 and relay this information to the smart device 3 or third-party software systems. Employing a camera 21 in the system 10 can act as a redundancy or control system or may be advantageous when retrofitting an older scale 1. Using an OCR-based camera 21 ensures that weight and ID tag 2 data can still be reconciled with the cloud database and transmitted to external systems without requiring direct hardware integration.

To set up a container 4 for use with system 10, the container 4 is initially registered by scanning the ID tag 2. The user then places the container 4 on the scale to capture the empty weight of the container 4. Alternatively, the empty weight of the container 4 is known. Next, the user enters the container's 4 SKU name or other identification data into the system 10, e.g., contents. If the container 4 is designated for unit mode, the user places one or more units of inventory into the container 4 to assess a per unit weight value. Multiple units of inventory may then be placed into the container 4 on the scale 1 to allow the scale 1 and system 10 to verify the unit weight value. If the container is designated for weight mode, the inventory may be placed in the container 4 and the total weight value (metric or imperial) is displayed and stored.

Each container 4 is registered with a unique ID tag 2 that is linked to a SKU or container 4 ID stored in the cloud database, enabling future cycle counts to reconcile inventory against expected values. Alternatively, upon scanning the ID tag 2 using handheld reader 5, reader 8, or another scanning device, the system 10 may retrieve data from the container 4 such as name, SKU, unit weight if in unit mode or weight if in weight mode, and contents from an external inventory management system using a linked tracking identifier. The retrieved data is then pre-populated in the container setup interface displayed on the smart device 3, laptop 6, or integrated connected hardware 9 prior to any manual entry by the user, allowing for faster setup and improved accuracy.

In embodiments, the system 10 may include advanced set up features or modes to facilitate faster inventory management. For example, during the container 4 setup process, a user may scan an additional ID tag 2, which may be in the form of an RFID, barcode, or QR code, or other identifiable label using handheld reader 5, fixed reader 8, camera 21 or other form of wired or wireless ID tag 2 scanner. Upon scanning the additional ID tag 2, the system 10 automatically retrieves preconfigured container 4 data from the cloud database, an external inventory management system or other third-party software. The retrieved data may include: container 4 name; SKU; default unit weight value if applicable; unit mode designation; if applicable; and/or contents. Where applicable, the system 10 may automatically assign the container 4 to weight mode or unit mode depending on the data linked to the scanned additional ID tag 2.

In this fashion, each container 4 is automatically registered and configured without requiring the user to manually input container fields such as SKU, unit weight, or description. The pre-populated data is displayed on the smart device 3 laptop 6, or integrated connected hardware 9 (e.g., via GUI 17), confirming to the user that setup has been completed. This advanced setup capability enables rapid deployment of tagged containers 4, reduces user error associated with manual data entry, and ensures consistency of container 4 configurations across environments.

To count inventory, the user may initiate a smart device 3, laptop 6, or integrated connected hardware 9 or simply place a container 4 on the scale 1. The ID tag 2 on the container 4 is scanned using the handheld reader 5, reader 8 or via the camera 21. The system 10 records the weight of the container 4 via connection cable 7 or via a wireless interface. The system 10 associates the recorded weight with container 4 or its linked SKU and, based on the specific configuration, the system 10 calculates either the total weight of inventory contents if in weight mode or the number of units using stored unit weights if in unit mode. The updated inventory data is then stored in the internal database or on the cloud database.

Optionally, after internal inventory updates are completed, the user may initiate a reconciliation process with external systems such as Metrc, BioTrack, enterprise resource planning (ERP) software, warehouse management system (WMS) or other third-party software platforms. For each container 4 or SKU, the system 10 retrieves the corresponding expected values from the external system, compares the external values to stored or internal values, and keeps track of and/or displays any discrepancies on smart device 3, laptop 6, or integrated connected hardware 9.

In cases where a discrepancy is noted, the user may select a predefined reason for the discrepancy, such as shrinkage, theft, loss, mislabeling, or scale 1 error. Discrepancies are logged and may be exported as a CSV file or optionally transmitted back to the external system in real time or batched for later synchronization. The user name may be associated with each discrepancy and a discrepancy report may be available on request.

System 10 may be configured to ensure that the scale 1 is tared before each measurement cycle. Presence detection logic determines when container 4 is placed on or removed from the scale 1. Once placement is detected, the system 10 records the weight via cable 7 (RS232 or USB) or wireless connection to smart device 3, desktop or laptop 6, or integrated connected hardware 9. When container 4 is removed, the interface running on smart device 3, desktop or laptop 6, or integrated connected hardware 9 resets automatically, preparing the system 10 for the next ID tag 2 scan and measurement event.

The presently disclosed system 10 is applicable across a wide range of industries where inventory accuracy, compliance, and efficiency are critical. For example, in the cannabis industry, the system 10 facilitates dispensary compliance auditing through integration with state-mandated platforms such as Metre and BioTrack. Flower jars, cartridges, and edibles may be stored in container 4, each marked with an ID tag 2 and measured using the scale 1 in a fashion similar to the one described above. This enables real-time visibility into inventory, logs discrepancies such as shrinkage or theft, and automatically triggers re-ordering when the recorded values fall below a designated threshold.

In healthcare environments, particularly surgical centers and hospitals, the system enables the tracking of orthopedic implants, surgical screws, trays, and other high-value hardware. ID tags 2 affixed to containers 4 provide staff immediate access to container information, including SKU, contents, and unit weight value. ID tag 2 scans may be performed through, for example, handheld reader 5, and weight capture may be achieved via the scale 1 connected to and displayed on, for example, smart device 3 and automatically reconciled with hospital inventory and compliance systems, ensuring accuracy for billing, regulatory adherence, and prevention of unauthorized usage.

Similarly, the aerospace industry will enjoy similar benefits using the present system 10. Aerospace parts, fasteners, and consumables can be tracked in real time, with each container 4 tagged by ID tag 2. The system may be integrated into aviation MRO platforms to reduce downtime, ensure compliance with FAA safety audits, and generate real-time discrepancy reports.

In the jewelry industry, the system 10 provides a secure and auditable method for tracking precious metals, gemstones, and finished jewelry pieces. The system 10 may be automatically synchronized with ERP systems to ensure inventory accuracy, theft prevention, and detailed audit reporting.

Within warehousing and fulfillment operations, the system 10 automates cycle counts by leveraging any of the supported weight monitoring devices, including smart device 3, laptop 6, integrated connected hardware 9, and/or camera 21. This multi-device interoperability reduces the labor required for manual cycle counts, increases efficiency, and provides real-time discrepancy logging for integration into WMS platforms.

In manufacturing environments, the disclosed system 10 assists with in-process material tracking by weighing raw materials prior to use. Automatic calculation of unit counts ensures accurate monitoring of bolts, fasteners, and components, reducing downtime and supporting just-in-time production scheduling.

Retail operations, including independent hardware stores and specialty retailers, may also benefit from the disclosed system 10. The system 10 may be configured to provide store managers real-time visibility into stock levels for high-turnover SKUs. Automatic alerts and re-order workflows reduce out-of-stock events and improve overall operational efficiency.

The pharmaceutical industry provides another example where the disclosed system delivers substantial value. Containers of pill bottles, vials, or liquid medications within container 4 may be tagged with ID tag 2 and scanned, e.g., using handheld reader 5. The scale 1 captures corresponding weight values. The system integrates with pharmaceutical compliance platforms, ensuring FDA regulatory adherence, accurate reporting, and prevention of distribution discrepancies.

In embodiments, the reader 5 scans an employee ID or other form of identification to link inventory reconciliations, transactions, logs, edits or other actions to that employee. In other embodiments, the system 10 logs the location, room, area, building, compartment, department, business, of where the inventory reconciliation or transaction happened or logs where the container 4 is located or going.

In still other embodiments, artificial intelligence (AI) may be utilized from weight readings, weight value, unit readings, and inventory transaction data for inventory and business visibility. It is envisioned that the AI may include predictive analytics, predicting trends, predicting usage, predicting patterns, and/or other forms of analysis.

The above-noted application may include a mobile application and/or a web-based application, thus enabling access from any suitable computing device connected to the internet, e.g., smart device 3. In aspects, an application may be accessed by scanning a QR code on an ID tag 2 associated with a container 4, either on the user-side, e.g., to view information, enter purchase information, etc., or on the administrator side, e.g., to set prices or taxes, add additional information, monitor sales, etc. Location tracking, e.g., via GPS, Wi-Fi location tracking, or other suitable location tracking, may be employed to locate a container 4 and/or provide directions to the container 4.

An application in accordance with the present disclosure may further leverage artificial intelligence (AI) and/or machine learning. As a non-limiting example, with respect to ingredients stored in the container 4, real-time amounts of ingredients stored in the container 4 may be automatically uploaded to a third-party software, e.g., Kitchen AI application, to provide real-time information with respect to available ingredients without requiring user data input. Thus, a user can browse and select recipes for which all ingredients, in adequate amounts, are present, without the worry of out-of-date data. As another example, with or without AI, nutritional and caloric information for the amount of each ingredient utilized can be precisely determined and utilized to provide nutritional and caloric data for prepared meals. The above is not limited to cooking; rather, as another example, the types, amounts, and costs of raw materials can be calculated and utilized for jewelers, machinists, wood workers, welders, etc. to track inventory, inform customers, and/or set pricing.

While several aspects of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular aspects. Those skilled in the art will envision other modifications within the scope and spirit of the claims appended hereto.

What is claimed is:

1. A system for reconciling inventory, comprising:
a scale configured to weigh a container having inventory disposed therein;
an identification tag disposed on the container, the identification tag including scannable indicia disposed thereon containing data about the inventory;
a reader configured to scan and read the scannable indicia and provide the data to a smart device; and
a processor disposed in the smart device or scale configured to analyze the data from the identification tag and a weight value from the scale to determine an updated quantity of inventory in the container, the processor comparing the updated quantity of inventory against a known quantity of inventory stored in the processor or a cloud database to determine an inventory discrepancy, the processor displaying the inventory discrepancy on the smart device.

2. The system of claim 1, wherein the data on the identification tag includes a name of the inventory, a SKU of the inventory, unit weight of the inventory, weight data of the inventory, quantity of the inventory, expiration date of the inventory, room and location of where the inventory reconciliation took place, or where the container is located.

3. The system of claim 1, wherein the scale is configured to communicate the weight value to the smart device via a communication cable, wirelessly, or via a camera.

4. The system of claim 1, wherein the reader is configured to communicate with a cloud database which stores data relating to the container and inventory.

5. The system of claim 1, wherein the processor includes a comparison engine configured to associate the identification tag with the weight value and compare the result to stored data.

6. The system of claim 5, wherein the processor includes an output module configured to update the result in real time.

7. The system of claim 1, wherein the identification tag is at least one of a RFID tag, barcode, or QR code.

8. The system of claim 1, wherein the reader is at least one of a RFID reader, a barcode reader, or a camera.

9. The system of claim 4, wherein the processor is configured to communicate with the cloud database to reconcile inventory discrepancies with an external inventory management system.

10. The system of claim 9, wherein inventory discrepancies are logged with a selectable reason for each discrepancy.

11. The system of claim 5, wherein the comparison engine is configured to calculate a unit weight based on an entered number of units and a measured total weight of inventory within the container.

12. The system of claim 1, wherein upon scanning the identification tag with the reader, the system is configured to retrieve and pre-populate details of the container including at least one of a container name, a SKU, a unit weight, and inventory contents based on a tracking identifier obtained from an external inventory management system.

13. The system of claim 1, further comprising an automation engine configured to execute rule-based triggers defined as IF-THEN statements, wherein each rule includes a condition associated with a container, and a corresponding action to be performed when the condition is satisfied, including automated re-ordering of inventory when a weight or unit threshold is reached.

14. The system of claim 1, wherein the system adapted to integrate with at least one of a Point-Of-Sale (POS) system, enterprise resource planning (ERP) system, or a warehouse management software (WMS) system to determine if there is a discrepancy in the inventory.

15. A method for reconciling inventory, comprising:
configuring a scale to weigh a container having inventory disposed therein;
scanning an identification tag disposed on the container with a reader, the identification tag including scannable indicia disposed thereon containing data about the inventory;
providing the data to a smart device;
analyzing the data from the identification tag with a processor disposed in the smart device or scale and a weight value from the scale to determine an updated quantity of inventory in the container;
comparing the updated quantity of inventory against a known quantity of inventory stored in the processor or a cloud database to determine an inventory discrepancy; and
displaying the inventory discrepancy on the smart device.

16. The method of claim 15, further comprising integrating with at least one of a Point-Of-Sale (POS) system, enterprise resource planning (ERP) system, or a warehouse management software (WMS) system to determine if there is a discrepancy in the inventory.

17. The method of claim 16, further comprising logging discrepancies between the updated quantity of inventory and the known quantity of inventory with a user defined reason.
